(19) United States
(12) Patent Application Publication
(10) Pub. No.: US 2026/0201490 A1
(43) Pub. Date: Jul. 16, 2026

(54) Method of manufacturing steel press parts with low environmental impact

(71) Applicant: ArcelorMittal, Luxembourg (LU)

(72) Inventors: Maxime BROSSARD, ARS-LAQUENEXY (FR); Raisa GRIGORIEVA, Metz (FR); Tiago MACHADO AMORIM, Longeville Les Metz (FR); Pascale FELTIN, SAINT PRIVAT LA MONTAGNE (FR)

(21) Appl. No.: 19/134,911

(22) PCT Filed: Dec. 9, 2022
(86) PCT No.: PCT/IB2022/061993

§ 371 Date: Jun. 2, 2025

(51) Int. Cl. C21D 1/673; C21D 1/18; C21D 6/00; C21D 9/46; C22C 21/10; C22C 38/02; C22C 38/04; C22C 38/06; C22C 38/28; C22C 38/32

(52) U.S. Cl. CPC C21D 1/673; C21D 1/18; C21D 6/002; C21D 6/005; C21D 6/008; C21D 9/46; C22C 21/10; C22C 38/02; C22C 38/04; C22C 38/06; C22C 38/28; C22C 38/32; C21D 2211/002; C21D 2211/005; C21D 2211/008

(57) ABSTRACT

A process for manufacturing a press-hardened part including the steps of A) providing a steel sheet provided with a coating, the coating including by weight percent, 7.5 to 8.5% of zinc, 2.7 to 3.5% of silicon, 1.0 to 3.0% of magnesium, up to 3.0% of iron as residual element, and optional elements chosen from Ni Zr, Hf, Sr, Sb, Pb, Ti, Ca, Mn, Sn, La, Ce, Cr or Bi, the content by weight of each element being less than 0.3% and unavoidable impurities up to 0.02%, the balance being aluminum, B) cutting of the coated steel sheet to obtain a blank, C) heating the coated steel sheet in a furnace at a temperature set from 900 to 950° C. and during a time from 2.5 to 4.0 minutes, D) transferring into a press tool, and E) press-hardening to obtain press-hardened part.

The present invention relates to a method for the manufacture of steel press hardened parts. The method is effective in terms of energy savings and environmental impact during manufacturing process. The invention is particularly well suited for the manufacture of automotive vehicles.

### BACKGROUND

In recent years the use of coated steels in hot stamping and press-hardening processes to manufacture parts has become important, especially in the automotive industry. Fabrication of such parts may include the following main steps:
Coating of a steel sheets by hot dipping in a metallic bath,
Trimming or cutting for obtaining blanks,
Heating the blanks in order to obtain alloying of the steel substrate with the coating, as well as the austenitizing of the steel, and
Press hardening of the part in order to obtain a predominantly martensitic microstructure.

### SUMMARY OF THE INVENTION

Thanks to press-hardening and the resulting microstructure, the parts have a yield strength which is higher than without press-hardening and well controlled. Such parts can be used for crash modules of automobiles.

The mandatory heating step is directly impacting the energy consumption of the manufacturing process, and the CO₂ emissions generated by said process. In a global ambition to reduce the impact of climate change and global warming, the overall CO₂ emissions of the manufacturing process must be reduced. A shorter duration of the heating step induces a lower energy consumption along manufacturing the process.

During heating, the steel sheet including the coating is heated above the temperature at which the microstructure of steel is completely transformed into austenite (above Ac3 temperature). After heating, the fully austenitized steel sheet is transferred into a press-hardening tools. Said press-hardening tools perform both press forming at high temperature and subsequently press-hardening by quenching the steel sheet in the press tools. The quenching by press-hardening is performed by controlling the cooling speed so that the part is hardened. In most cases, the targeted microstructure is predominantly martensitic.

The patent application publication WO2017017521 A1 discloses a method for the manufacture of a phosphatable part starting from a steel sheet coated with a metallic coating based on aluminum. The metallic coating comprises from 4.0 to 20.0% by weight of zinc, from 1.0 to 3.5% by weight of silicon, optionally from 1.0 to 4.0% by weight of magnesium, and optionally additional elements chosen from Pb, Ni, Zr, or Hf, the content by weight of each additional element being less than 0.3% by weight, the balance being aluminum and unavoidable impurities and residuals elements, wherein the ratio Zn/Si is between 3.2 and 8.0.

It is an object of the present invention to provide a method to produce a press-hardening part, with a reduced CO₂ footprint, without decreasing the paint adherence properties while ensuring the proper microstructure is achieved.

The present invention provides a process for manufacturing a press-hardened part comprising the following steps:
A) The provision of a steel sheet provided with a coating, said coating comprising by weight percent, 7.5 to 8.5% of zinc, 2.7 to 3.5% of silicon, 1.0 to 3.0% of magnesium, up to 3.0% of iron as residual element, and optional elements chosen from Ni Zr, Hf, Sr, Sb, Pb, Ti, Ca, Mn, Sn, La, Ce, Cr or Bi, the content by weight of each element being less than 0.3% and unavoidable impurities up to 0.02%, the balance being aluminum,
B) The cutting of the coated steel sheet to obtain a blank,
C) Heating said coated steel sheet in a furnace at a temperature set from 900 to 950° C. and during a time from 2.5 to 4.0 minutes,
D) Transferring of said heated coated steel sheet into a press tool,
E) Press-Hardening of said coated steel sheet to obtain press-hardened part.

The present invention also provides a process for manufacturing a press-hardened part as described above, wherein the coating of step A) comprises, in weight percent, from 1.5 to 3.0% of magnesium.

The present invention also provides a process for manufacturing a press-hardened part as described above, wherein the coating of step A) comprises, in weight percent up to 2% iron.

### DETAILED DESCRIPTION

The steel sheet used in the present invention is coated with a metallic coating, said coating comprising by weight percent, 7.5 to 8.5% of zinc, 2.7 to 3.5% of silicon, 1.0 to 3.0% of magnesium, up to 3.0% of iron as residual element, and optional elements chosen from Ni Zr, Hf, Sr, Sb, Pb, Ti, Ca, Mn, Sn, La, Ce, Cr or Bi, the content by weight of each element being less than 0.3% and unavoidable impurities up to 0.02%, the balance being aluminum.

Preferably, the coating comprises, in weight percent, from 1.5 to 3.0% of magnesium.

Preferably, the coating comprises up to 2.0% weight iron.

In a preferred embodiment, up to 100 ppm in weight of calcium is added.

Preferably, the coating may contain unavoidable impurities up to 0.01 wt. %.

The steel sheet used in the invention can be manufactured by hot dip galvanizing in a bath, the temperature of which is set from 600 to 700° C., preferably from 620 to 650° C. When the coating is applied by hot dip coating, iron comes from the dissolution of the steel sheet in the hot dip coating bath and can vary during production.

The coating weight is set during the wiping process by gas knives in a range from 50 to 500 g/m², possibly from 80 to 150 g/m² and preferably from 90 to 120 g/m² for the sum of both sides of the steel sheet.

Before being coated, the steel sheet according to the invention can be obtained by hot rolling and optionally cold rolling depending on the desired thickness, which can be for example from 0.5 to 3.0 mm, preferably from 0.7 to 2.0 mm, or even 1.0 to 1.5 mm.

The method according to the invention comprises the following steps:
A) The provision of a steel sheet provided with a coating, said coating comprising by weight percent, 7.5 to 8.5% of zinc, 2.7 to 3.5% of silicon, 1.0 to 3.0% of magnesium, up to 3.0% of iron as residual element, and optional elements chosen from Ni Zr, Hf, Sr, Sb, Pb, Ti, Ca, Mn, Sn, La, Ce, Cr or Bi, the content by weight of each element being less than 0.3% and unavoidable impurities up to 0.02%, the balance being aluminum,
B) the cutting of the coated steel sheet to obtain a blank,
C) Heating said coated steel sheet in a furnace at a temperature set from 900 to 950° C. and during a time from 2.5 to 4.0 minutes,
D) Transferring of said heated coated steel sheet into a press tool, and
E) Press-Hardening of said coated steel sheet to obtain press-hardened part.

In step A), the steel sheet used is made of steel for heat treatment as described in the European Standard EN 10083. It can have a tensile resistance superior to 500 MPa, advantageously between 500 and 2000 MPa before or after heat-treatment.

The weight composition of steel sheet is preferably as follows: 0.03%≤C≤0.50%; 0.3%≤Mn≤3.0%; 0.05%≤Si≤0.8%; 0.015%≤Ti≤0.2%; 0.005%≤Al≤0.1%; 0%≤Cr≤2.50%; 0%≤S≤0.05%; 0%≤P≤0.1%; 0%≤B≤0.010%; 0%≤Ni≤2.5%; 0%≤Mo≤0.7%; 0%≤Nb≤0.15%; 0%≤N≤0.015%; 0%≤Cu≤0.15%; 0%≤Ca≤0.01%; 0%≤W≤0.35%, the balance being iron and unavoidable impurities from the manufacture of steel.

For example, the steel sheet is 22MnB5 with the following weight composition: 0.20%≤C≤0.25%; 0.15%≤Si≤0.35%; 1.10%≤Mn≤1.40%; 0%≤Cr≤0.30%; 0.020%≤Ti≤0.060%; 0.020%≤Al≤0.060%; 0.002%≤B≤0.004%, the remainder being iron and unavoidable impurities from the manufacture of steel.

In another embodiment, the steel sheet has the following weight composition: 0.24%≤C≤0.38%; 0.40%≤Mn≤3%; 0.10%≤Si≤0.70%; 0.015%≤Al≤0.070%; Cr≤2%; 0.25%≤Ni≤2%; 0.015%≤Ti≤0.10%; Nb≤0.060%; 0.0005%≤B≤0.0040%; the remainder being iron and unavoidable impurities resulting from the manufacture of steel.

Alternatively, the steel sheet can have the following weight composition: 0.30%≤C≤0.40%; 0.5%≤Mn≤1.0%; 0.40%≤Si≤0.80%; 0.1%≤Cr≤0.4%; 0.1%≤Mo≤0.5%; 0.01%≤Nb≤0.1%; 0.01%≤Al≤0.1%; 0.008%≤Ti≤0.003%; 0.0005%≤B≤0.003%; 0.0%≤P≤0.02%; 0.0%≤Ca≤0.001%; 0.0%≤S≤0.004%; 0.0%≤N≤0.005%, the remainder being iron and unavoidable impurities resulting from the manufacture of steel.

In another embodiment, the steel sheet has the following weight composition: 0.040%≤C≤0.100%; 0.80%≤Mn 2.00%; 0%≤Si≤0.30%; 0%≤S≤0.005%; 0%≤P≤0.030%; 0.010%≤Al≤0.070%; 0.015%≤Nb≤0.100%; 0.030%≤Ti≤0.080%; 0%≤N≤0.009%; 0%≤Cu≤0.100%; 0%≤Ni≤0.100%; 0%≤Cr 0.100%; 0%≤Mo≤0.100%, the balance being iron and unavoidable impurities from the manufacture of steel.

In another embodiment, the steel sheet has the following weight composition: 0.06%≤C≤0.1%, 1%≤Mn≤2%, Si≤≤0.5%, Al≤50.1%, 0.02%≤Cr≤0.1%, 0.02%≤Nb≤0.1%. 0.0003%≤B≤0.01%, N≤0.01%, S≤0.003%. P≤0.020% less than 0.1% of Cu, Ni and Mo, the remainder being iron and unavoidable impurities resulting from the manufacture of steel.

In another embodiment, the steel sheet has the following weight composition: 0.015%≤C≤0.25%; 0.5%≤Mn≤1.8%; 0.1%≤Si≤1.25%; 0.01%≤Al≤0.1%; 0.1%≤Cr≤1.0%; 0.01%≤Ti≤0.1%; 0%≤S≤0.01%; 0.001%≤B≤0.004%; 0%≤P≤0.020%; 0%≤N≤0.01%; the balance being iron and unavoidable impurities from the manufacture of steel.

Alternatively, the steel sheet has the following weight composition: 0.2%≤C≤0.34%; 0.5%≤Mn≤1.24%; 0.5%≤Si≤2.0%; 0%≤S≤0.01%; 0%≤P≤0.020%; 0%≤N≤0.01%, the balance being iron and unavoidable impurities from the manufacture of steel.

In step B), the steel sheet is cut into a blank. Said coated steel blank may have a thickness which is not uniform. This is the case of the so-called “tailored rolled blanks” which are obtained from cutting a sheet obtained by a process of rolling with an effort which is variable along the direction of the length of the sheet. Or this may be also the case of the so-called “tailored welded blanks” obtained by the welding of at least two sub-blanks of different thicknesses.

In step C), the blank is heat treated. If the heat treatment is longer than 4.0 minutes, the energy consumed during the press-hardening process is too high and the CO₂ footprint is also too high.

If the heat treatment is shorter than 2.5 minutes, the austenitizing of the steel sheet is incomplete before press-hardening. As the steel sheet is not fully austenitized, the microstructure of the part is different from the targeted microstructure, even if the cooling speed is sufficient. In this case, the microstructure of the final part is not predominantly martensitic. It can also highlight an excessive amount of ferrite, bainite or residual austenite.

The inventors have surprisingly found that the method according to the invention allows reaching the paint adherence property with heating time of 2.15 minutes or more, whatever the steel grade.

In step D), the coated steel sheet is transferred in the press forming tools and hot formed at a temperature from 600 to 900° C. After forming, the steel part is quenched into the press forming tools or transferred to a specific quenching tool. Quenching is performed at a cooling speed being faster than the critical cooling rate. The microstructure obtained is predominantly martensitic. The amounts of ferrite, bainite or retained austenite are limited to a volume fraction depending on the steel grade.

The invention will now be illustrated by tests as an illustration and not as a limitation.

### Examples

In the examples, three different compositions of steel grades with different sheet thicknesses are tested with different coating compositions and coating weights, as shown in Table 2:

Steel grade A has a composition of 0.23 wt. % of carbon, 1.19 wt. % of manganese, 0.26 wt. % of silicon, 0.18 wt. % of chromium, 0.03 wt. % of aluminum, 0.04 wt. % of titanium and 0.002 wt. % of boron. The targeted microstructure of steel grade after a fully austenitizing heat-treatment followed by press-hardening comprises, in terms of volume fraction, more than 95% of martensite and less than 5% of ferrite plus bainite.

Steel grade B has a composition of 0.33 wt. % of carbon, 0.62 wt. % of manganese, 0.57 wt. % of silicon, 0.37 wt. % of chromium, 0.04 wt. % of aluminum, 0.01 wt. % of titanium and 0.002 wt. % of boron. The targeted microstructure of steel grade B after a fully austenitizing heat-treatment followed by press-hardening comprises, in terms of volume fraction, more than 95% of martensite and less than 5% of ferrite plus bainite.

Steel grade C has a composition of 0.076 wt. % of carbon, 1.60 wt. % of manganese, 0.36 wt. % of silicon, 0.08 wt. % of chromium, 0.04 wt. % of aluminum, 0.02 wt. % of titanium and 0.003 wt. % of boron. The targeted microstructure of steel grade C after a fully austenitizing heat-treatment followed by press-hardening comprises, in terms of volume fraction, more than 50% of martensite and less than 45% of ferrite plus bainite.

### Microstructure and Thickness of Interdiffusion Layer

Trials were heated and press-hardened according to the parameters gathered in Table 2. During press-hardening, the cooling speed was faster than the critical cooling rate.

The phase contents in terms of volume fraction are determined through the following method: a specimen is cut from the press hardened steel part, polished and etched with a reagent known per se, for example Nital reagent, to reveal the microstructure. The section is afterwards examined through optical or scanning electron microscope, for example with a Scanning Electron Microscope with a Field Emission Gun (“FEG-SEM”) at a magnification greater than 5000×, coupled to an Electron Backscatter Diffraction (EBSD) device.

Results are gathered in table 2.

### Paint Adherence

This test is used to determine the paint adherence of the hardened parts.

After press-hardening, the parts evaluated for microstructure determination underwent a phosphating step realized by dipping into a bath for 3 minutes at 50° C. The components of the phosphating bath are Gardobond® products from supplier Chemetall. Their concentrations are disclosed in table 1.

TABLE 1
Component concentrations in phosphating bath

| Gardobond ® | | | | | | | | |
|---|---|---|---|---|---|---|---|---|
| product type | R24TA | H7101 | H7141 | H7257 | H7102 | H7141 | H7255 | H7004 |
| Concentration | 58.0 | 7.0 | 5.0 | 4.5 | 4.0 | 2.4 | 2.4 | 0.4 |
| (g/L) | | | | | | | | |

The samples were then wiped with water and dried with hot air

After phosphatizing, an e-coating layer of 20 μm is deposited on Trials 1 to 5. To this end, all trials were dipped into a bath comprising an aqueous solution comprising Pigment paste® W9712-N6 and Resin blend® W7911-N6 of PPG Industries during 180 seconds at 30° C. A 200V current was applied. Then, the panel was wiped and cured in the oven at 180° C. for 35 minutes.

Then, painted parts are dipped into a sealed box comprising demineralized water during 10 days at a temperature of 50° C. according to NF EN ISO 2409 standard. After the dipping, a grid is realized with a cutter. The paint is ripped with a piece of adhesive tape.

The removed paint is assessed by naked eyes: 0 means excellent, in other words, there is no paint removed; and 5 means very bad, in other words, there is lots of paint removed. A satisfying result is 0 or 1. A result of 2 or more is not sufficient in terms of paint adherence. Three to six samples were performed for each trial, the result as a mean value for each trial, is shown in table 2.

TABLE 2
Microstructure and Paint adherence

| | | | | | | | | | | Microstructure content | | Paint |
|---|---|---|---|---|---|---|---|---|---|---|---|---|
| | | Sheet | | | | | Total | Heat Treatment | | (volume %) | | Adherence in |
| | | Thick- | Coating | | | | coating | Parameters | | | Phases | humid |
| | Steel | ness | composition (wt %) | | | | weight | Furnace | Dwell Time | Phase | Ferrite + | conditions |
| Trial Nr | Grade | (mm) | Zn | Si | Mg | Al | (g/m²) | T (° C.) | (min) | Martensite | Bainite | (Eye quotation) |
| 1 | A | 1.5 | 0.0 | 9.0 | 0.0 | Balance | 150 | 900 | 3.00 | <90 | >10 | 2.3 |
| 2* | A | 1.5 | 8.2 | 3.2 | 2.0 | Balance | 120 | 900 | 2.00 | >95 | <5 | 0.2 |
| 3 | B | 1.5 | 8.2 | 3.2 | 2.0 | Balance | 120 | 900 | 2.20 | <90 | >10 | 0.3 |
| 4* | B | 1.5 | 8.2 | 3.2 | 2.0 | Balance | 120 | 900 | 3.00 | >95 | <5 | 0.3 |
| 5 | C | 1.5 | 8.2 | 3.2 | 2.0 | Balance | 120 | 900 | 2.20 | <40 | >60 | 0.3 |
| 6* | C | 1.5 | 8.2 | 3.2 | 2.0 | Balance | 120 | 900 | 3.00 | >50 | <40 | 0.8 |
| 7* | A | 1.5 | 8.2 | 3.2 | 2.0 | Balance | 120 | 930 | 2.50 | >95 | <5 | 1.0 |
| 8 | A | 1.35 | 8.2 | 3.2 | 2.0 | Balance | 120 | 930 | 2.15 | <90 | >10 | 1.0 |
| 9* | A | 1.35 | 8.2 | 3.2 | 2.0 | Balance | 120 | 950 | 2.50 | >95 | <5 | 1.0 |

*according to the invention underlined values not according to the invention

Trial 1 with a coating not according to the invention but a heat treatment according to the invention doesn't show a sufficient paint adherence. Trial 1 neither achieve the targeted microstructure.

Trials 3, 5 and 8 with a coating according to the invention but a heat treatment shorter than the invention didn't achieve the targeted microstructure.

Trials 2, 4, 6, 7 and 9 according to the invention present a satisfying paint adherence equal or even better than the counter-examples, as well as the targeted microstructure, whatever the steel grade.

1-3. (canceled)

4: A process for manufacturing a press-hardened part, the process comprising the following steps:
A) providing a steel sheet having a coating to define a coated steel sheet, the coating comprising by weight percent, 7.5 to 8.5% of zinc, 2.7 to 3.5% of silicon, 1.0 to 3.0% of magnesium, up to 3.0% of iron as residual element, and optional elements chosen from Ni Zr, Hf, Sr, Sb, Pb, Ti, Ca, Mn, Sn, La, Ce, Cr or Bi, a content by weight of each element being less than 0.3% and unavoidable impurities up to 0.02%, a balance being aluminum;
B) cutting of the coated steel sheet to obtain a blank;
C) heating the coated steel sheet in a furnace at a temperature set from 900 to 950° C. and for a time from 2.5 to 4.0 minutes,
D) transferring of the heated coated steel sheet into a press tool; and
E) press-hardening of the coated steel sheet to obtain press-hardened part.

5: The process as recited in claim 4 wherein the coating of step A) comprises, in weight percent, from 1.5 to 3.0% of magnesium.

6: The process as recited in claim 5 wherein the coating of step A) comprises, in weight percent up to 2% iron.

7: The process as recited in claim 4 wherein the coating of step A) comprises, in weight percent up to 2% iron.
